(19) United States
(12) Patent Application Publication
(10) Pub. No.: US 2015/0006032 A1
(43) Pub. Date: Jan. 1, 2015

(54) Vehicle Generating System

(71) Applicant: Tremaine Jackson, West Covina, CA (US)

(72) Inventor: Tremaine Jackson, West Covina, CA (US)

(21) Appl. No.: 13/623,864

(22) Filed: Sep. 20, 2012

(51) Int. Cl. B60W 30/18; B60W 10/20; B60W 10/06

(52) U.S. Cl. CPC B60W 30/18; B60W 10/06; B60W 10/20
USPC 701/41

(57) ABSTRACT

A vehicle includes a processor for controlling the angular velocity of the shaft, whereby a transmission and gears are not used to change the velocity or direction of the vehicle. The processor operatively joins with the shaft, and signals to a shaft conversion device the desired velocity, acceleration, deceleration, and forward or rearward direction for the vehicle. An actuating arm in the shaft portion orients wheels in a desired direction. The vehicle also utilizes a Y-shaped engine having no moving parts. The engine utilizes man-made fuels. The processor further communicates with a chamber modulator in the engine to control the distribution of the fuel, and to convert liquid fuel into vapor fuel. An air intake receives air for performing combustion in the engine. The chamber modulator communicates with the air intake to regulate the air. The processor also helps control communication, aesthetic, and luxury features for the vehicle.

### CROSS-REFERENCE TO RELATED APPLICATIONS

The present Utility patent application claims priority benefit of the [U.S. provisional application for patent Ser. No. 61/626,897, entitled “Vehicle Generating System”, filed on 5 Oct. 2011 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to vehicles. More particularly, one or more embodiments of the invention relate to computer operated vehicles.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a vehicle is a mobile machine that is designed or used to transport passengers or cargo. Most often vehicles are manufactured, such as automobiles, motorcycles, trains, ships, boats and aircraft.

Typically, grain fuels are fuels produced from renewable resources. Examples include, without limitation biofuels, vegetable oil used as fuel, ethanol from corn grains, and methanol. Renewable fuels have gained in popularity due to their sustainability and low contributions to the carbon cycle.

Typically, a vehicle transmission is a mechanical device that can automatically change gear ratios as the vehicle moves, freeing the driver from having to shift gears manually. Most transmissions have a defined set of gear ranges, often with a parking feature that locks the output shaft of the transmission.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a sectioned top view of an exemplary computer operated vehicle, in accordance with an embodiment of the present invention;

FIG. 2 illustrates a top view of an exemplary shaft portion passing underneath an exemplary processor portion, in accordance with an embodiment of the present invention;

FIG. 3 illustrates a rear view of an exemplary shaft portion, in accordance with an embodiment of the present invention; and

FIG. 4 illustrates a front view of an exemplary shaft portion operatively joined with a shaft conversion device, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

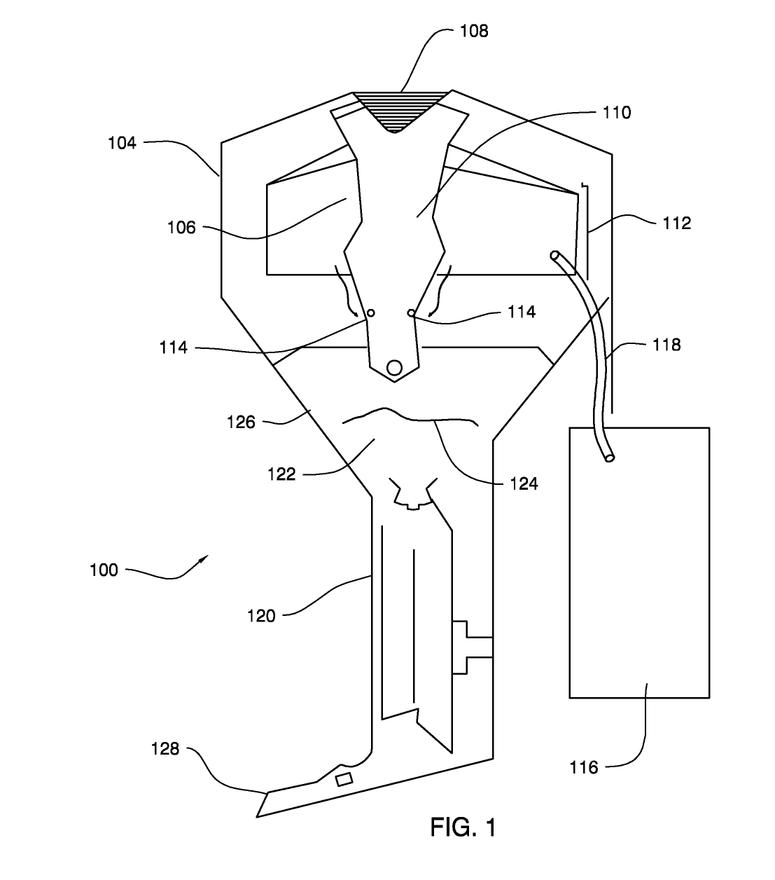

FIG. 1 illustrates a sectioned top view of an exemplary vehicle, in accordance with an embodiment of the present invention. In the present embodiment, there may be various types of vehicles that may be provided by preferred embodiments of the present invention. In one embodiment of the present invention, the vehicle 100 may utilize man-made fuels for power. The vehicle may further utilize a processor portion to accelerate and decelerate the vehicle without the use of a transmission or differentials. In one embodiment of the present invention, the vehicle may include an engine portion 104 that operatively joins with the processor portion. The engine portion may provide combustion functions including, without limitation, air intake, fuel dispersal, vapor exchange, and an exhaust. In some embodiments, the engine portion may utilize a unique Y-shape and man-made fuels to generate power during combustion. A series of vapor exchanges may occur in the engine portion during combustion for generating optimal fuel efficiency. In some embodiments, the engine portion may include an air intake portion 106 positioned towards a front end of the vehicle. The air intake portion may allow air to flow from the external area of the vehicle to the internal regions of the engine portion to fuel combustion. The intake portion may include an intake filter 108 for providing clean air to the engine portion. An air accelerator 110 may increase the velocity of the air to provide more efficient combustion. In one embodiment of the present invention, a chamber modulator 112 may process the velocity of the incoming air, and uses this information to convert the liquid fuel to a vapor. A multiplicity of ignition prongs 114 may ignite the vapor at different time intervals per commands received from the processor unit. In some embodiments, a fuel tank 116 may store the fuel, which moves to the chamber modulator through at least one fuel tube 118. After the combustion process, the resultant exhaust may exit through the vehicle through an exhaust portion 120. An exhaust suction device 122 may help to pass exhaust through an exhaust filter 124 in the engine portion by forming a vacuum that sucks exhaust through a combustion valve 126, and finally spewing the exhaust from the vehicle through a spew chamber 128.

In the present embodiment, the vehicle may provide a novel form of transportation that integrates a plethora of technological innovations with the processor portion to provide fuel efficient propulsion. The vehicle also utilizes the processor portion to accelerate and decelerate the vehicle without utilizing a transmission or differentials. The vehicle may also utilize the processor portion to provide innovative communication with other vehicles, aesthetic, and luxury features. In some embodiments, the vehicle may utilize man-made fuels. Potential fuel used in this vehicle, P110. Erodic Fuel Extract, 401. Grain Measure Extract, & 013. Erodic Fuel Extract. All of horticulture nature while simultaneously using a processor portion to accelerate and decelerate the vehicle without utilizing a transmission. The vehicle may provide a processor portion for controlling the distribution of man-made fuels from the fuel tank to the combustion engine, and rotating the axles of the wheels without requiring gears and differentials from the transmission. In one embodiment, the processor portion may position beneath a seat in the vehicle. However in other embodiments, the processor may position anywhere on the vehicle that allow the processor portion to operatively join with other components of the vehicle.

In one embodiment of the present invention, the engine portion may operatively joins with the processor portion. The engine portion may provide combustion functions including, without limitation, air intake, fuel dispersal, vapor exchange, ignition, and exhaust distribution. In some embodiments, the engine portion may utilize a unique Y-shape, include no moving parts, and utilizes an aero dynamic shape. The engine portion may utilize man-made fuels to generate power for combustion. The significance of a Y-shape engine is its shape allows it to burn fuels which contain grains of various chemical elements as an option and not pollute. In one alternative embodiment, the vehicle may not utilize combustion, but rather a battery to generate power. In some embodiments, the fuel used for combustion may include minuscule grains of surfer or coal that saturate with the fuel to provide a more efficient combustion. However, in other embodiments, the grains may include other forms of various chemical elements. In some embodiments, the grains may include grain measure oil for producing grains that are saturated with fuel. The engine portion may burn the grain and fuel inside the chamber modulator, and count the saturated grains. The chamber modulator may take in the readings from the engine portion in the form of a ratio including, without limitation, air+fuel+grain. The chamber modulator may then transfer the saturated grains to a containment unit for combusting at a slightly higher level degree of burning. Those skilled in the art, in light of the present teachings will recognize that the grains provide enhanced power during combustion upon ignition. In this manner, a series of vapor exchanges during combustion may create optimal fuel efficiency. Suitable materials for fabricating the engine portion may include, without limitation, steel, cast iron, aluminum, iron, polymers, and alloys.

In some embodiments, the engine portion may include an air intake portion positioned towards a front end of the vehicle. The air intake portion may include spliced external air intake valves. In some embodiments, the intake portion may include an intake filter for providing clean air to the engine portion. The air intake portion may allow air to flow from the external area of the vehicle to the internal regions of the engine portion to actuate combustion. Those skilled in the art, in light of the present teachings will recognize that increasing the size of the intake portion and/or increasing the velocity of the vehicle increases the flow of air into the vehicle. In one embodiment, the air accelerator may increase the velocity of the air to provide more efficient combustion. The combustion chamber, which positions at the base of the air accelerator, may process the incoming air as the air enters through the air accelerator. Those skilled in the art, in light of the present teachings will recognize that the air passes through a series of filtered apertures prior to being processes by the combustion chamber. The air accelerator communicates the air velocity information to the chamber modulator for assessing a fuel to air ratio in the combustion.

In one embodiment of the present invention, the chamber modulator may process the velocity of the incoming air, and use this information to convert the liquid fuel to a vapor for combustion with the air. A multiplicity of ignition prongs may ignite the vapor and the air at different time intervals to create combustion. Those skilled in the art, in light of the present teachings will recognize that the processor portion may control the synchronization of the multiplicity of ignition prongs to provide optimum fuel efficiency. The ignitions may occur per commands received from the processor unit. The ignition prongs may include, without limitation, spark plugs, and a distributor. In some embodiments, a fuel tank may store the fuel, which moves to the chamber modulator through at least one fuel tube. The fuel tank may include a sensor that communicates with the chamber modulator to determine the quantity of liquid fuel to be transferred from the fuel tank to the chamber modulator for conversion to a vapor.

After the combustion process, the resultant exhaust may exit through the vehicle through an exhaust portion. An exhaust suction device may help to pass exhaust through an exhaust filter in the engine portion by forming a vacuum that sucks exhaust through a combustion valve, and finally spewing the exhaust from the vehicle through a spew chamber. Those skilled in the art, in light of the present teachings will recognize that exhaust is a byproduct of combustion. An efficient means for removing exhaust from the vehicle may create a more efficient combustion process.

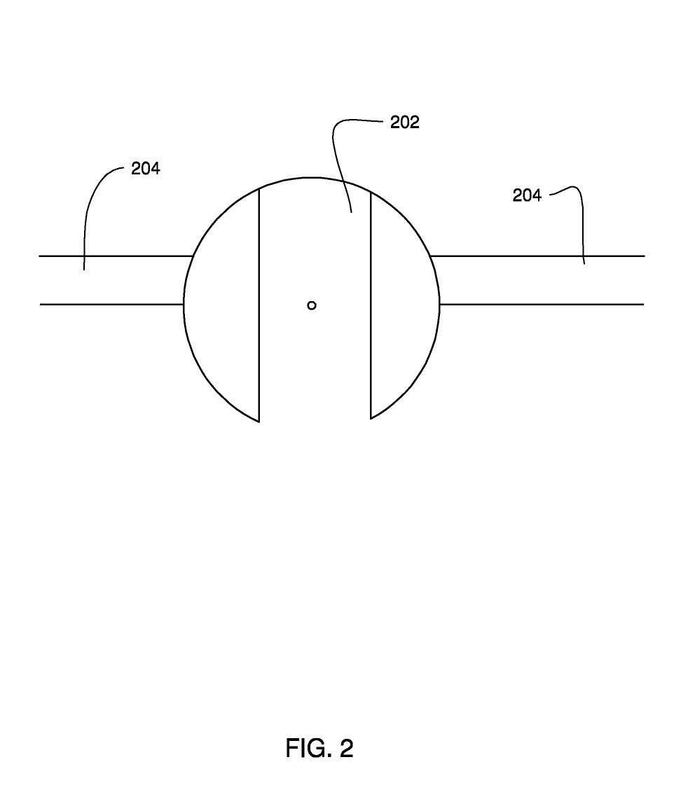

FIG. 2 illustrates a top view of an exemplary shaft portion passing underneath an exemplary processor portion, in accordance with an embodiment of the present invention. In the present embodiment, the vehicle may provide a processor portion 202 for controlling the distribution of man-made fuels from the fuel tank to the engine portion, and rotating the axles of the wheels without utilizing a transmission or differentials. The processor portion may also process and control communication, aesthetic, and luxury features for the vehicle.

In one embodiment of the present invention, the vehicle may include a shaft portion 204 that operatively joins with the processor portion. The shaft portion may rotate the wheels of the vehicle in both a forward and backward direction to allow the vehicle to move. The engine portion may provide the power to rotate the shaft portion. The processor portion may control the angular velocity of the rotation of the shaft portion. In this manner, the velocity of the vehicle may accelerate and decelerate without the utilization of gears in a transmission. A shaft conversion device 206 may receive the commands from the processor portion for actuating the rotation of the shaft portion. In one embodiment of the present invention, the vehicle may further include a multiplicity of communication, decorative, and luxury features for enhancing the aesthetic and functional aspects of the vehicle.

In the present embodiment, the vehicle may include a shaft portion that operatively joins with the processor portion. The shaft portion may rotate the wheels of the vehicle in both a forward and backward direction to allow the vehicle to move. The engine portion may provide the power to rotate the shaft portion. The processor portion may control the angular velocity of the rotation of the shaft portion. In this manner, the velocity of the vehicle may accelerate and decelerate without the utilization of gears in a transmission. In some embodiments, the processor portion may provide signals for timing the acceleration and deceleration of the angular velocity of the rotation of the shaft portion. For example, without limitation, the vehicle may commence movement from a still position. The angular velocity of the shaft portion may increase in a linear path, without the use of multiple sized gears integrated with each other. Those skilled in the art, in light of the present teachings will recognize that minimizing components and moving parts on the vehicle may reduce thermal energy and weight of the vehicle, thereby increasing fuel efficiency.

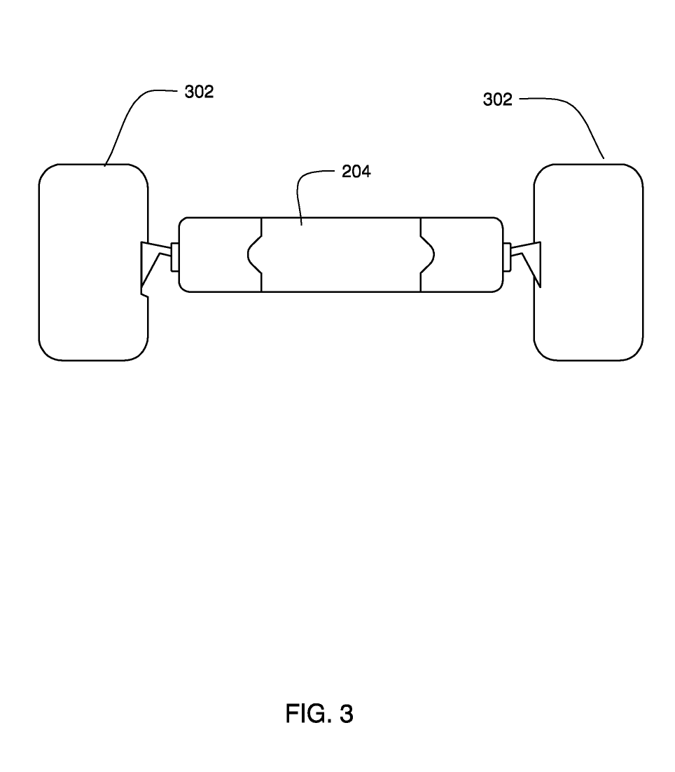

FIG. 3 illustrates a rear view of an exemplary shaft portion, in accordance with an embodiment of the present invention. In the present embodiment, the shaft portion may utilize either front wheel drive, or rear wheel drive features. The processor portion may control when each type of drive may be actuated. At least one wheel 302 may be oriented in a desired direction for steering.

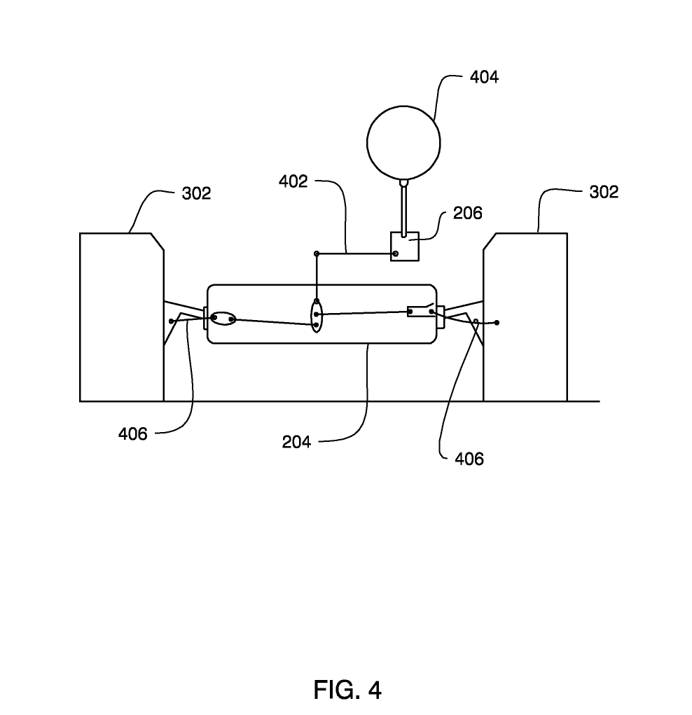

FIG. 4 illustrates a front view of an exemplary shaft portion operatively joined with a shaft conversion device, in accordance with an embodiment of the present invention. In the present embodiment, an actuating arm 402 operatively joins with a steering portion 404 to orient the at least one wheel in the desired direction. At least one tie rod 406 joins with the actuating arm in proximity to each wheel. Each tie rod may include sufficient flexible joints efficacious for pushing and pulling each wheel to the desired orientation. In some embodiments, the shaft portion may operatively join with the steering portion. The steering portion may rotate to orient each wheel in a desired direction. However in another embodiment, the processor portion may control the directional function of the steering portion.

In one embodiment of the present invention, an electronic conversion device may join with the shaft portion for receiving signals from the processor portion. The signals may then convert to mechanical rotation of the shaft portion. Those skilled in the art, in light of the present teachings will recognize that the processor portion may transmit digital or analog signals to the electronic conversion device. In some embodiments, the electronic conversion device may join with a front or rear shaft. In one embodiment of the present invention, the vehicle may further include a multiplicity of communication, decorative, and luxury features for enhancing the aesthetic and functional aspects of the vehicle.

In one embodiment of the present invention, the processor portion may also process and control communication, aesthetic, and luxury features for the vehicle. In one embodiment, the processor may include a transmitter/receiver for communicating with other units, including, without limitation, other computer operated vehicles, relay stations, radio towers, and satellites.

In yet another embodiment, an exterior portion of the vehicle may include numerous decorative features, including, without limitation, a bird shaped black diamond logo, whereby a white gold emblem may cover the diamond.

In yet another embodiment, the vehicle may include an entrée platter a compartment for keeping takeout food heated while driving. In yet another embodiment, the vehicle may include a real time navigational view finder for mapping and positioning. The real time navigational view finder may operatively join with the processor and a satellite. In yet another embodiment, the vehicle may include mood lights for providing ambiance and decorative features for vehicle. The mood lights may include carefully angled lights and small mirrors in variable that set create a desired atmosphere.

In yet another embodiment, the vehicle may include seats fabricated from luxury materials, including, without limitation, fur, leather, skin, and satin. The seats may further be operable to massage an operator and a passenger of the vehicle. The massage seats may operate while the vehicle is moving or resting in a parked position. In yet another embodiment, the vehicle may include a vertical window console for providing privacy for operators and passengers of the vehicle. The vertical window console may be positioned between the operator and the passenger.

In yet another embodiment, the vehicle may include night fall windows. The night fall windows may be operable to reclining a front windshield about 3″. In some embodiments, the night fall windows operate only when the vehicle is in the park position or not running. Those skilled in the art, in light of the present teachings will recognize that any attempt at moving the vehicle may result in the windshield automatically self-inclining as a safety measure. The night fall window may include a lock mode and a shield screen.

In yet another embodiment, the vehicle may include dimpled acoustic ceiling panels for absorbing and reflecting sound signals to a desired area of the vehicle and providing enhanced sound signals. In yet another embodiment, the vehicle may include at least one concealed projectors in proximity to the front of the vehicle for displaying custom features on a rear projection display. In yet another embodiment, the seats may rotate from the front of the vehicle to the rear of the vehicle to allow the passengers to view the beam from the projector on a rear display spread. In some embodiments, the rear display spread may include filtered LCD crystals, wires, and mild reflectors. The electricity generated throughout the display may be utilized to receive a beam of light from the projector and enhance the subsequent images. In one embodiment, the projectors may function only if the vehicle is in the park position and powered off

In yet another embodiment, the vehicle may include accident cushion walls with sensors that respond to an initial impact of an accident by releasing installation inflations in detected areas. In yet another embodiment, the vehicle may include luxury rims. Suitable materials for fabricating the luxury rims may include, without limitation, platinum, gold, and silver. In yet another embodiment, the vehicle may include, foresight view monitors. The foresight view monitors may include extended corners of the rear view mirror for viewing the vehicle's blind spot. In this manner, the blind spots gradually move with an approaching motorist for guiding the view. In some embodiments, the foresight view monitors a panoramic view. In some embodiments, the vehicle may include a pendulum grandfather clock. The clock may be digital and include numerous sizes and dimensions. In one alternative embodiment, the vehicle may include Dolby sound systems, and laptop computers perpetually plugged into the internet. In some embodiments the vehicle may include the feature of replacing the side panels via a suction tool for safely changing the color of the passenger vehicle in a controlled environment. Some aspects of what is pop art may apply to the inner plastic around the vehicle seat belt holder as applied art. In another embodiment the rear seats may lay completely flat, back to the floor forming a sleeper for viewing the rear display, may apply for only two rear seats, for safety feature works when vehicle is “off” in the parked position. In some embodiment of the vehicle may include sun screens that fill the window void electronically when window is down, form an additional compartment positioned around the window opening.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing luxury vehicles that utilize man-made fuel and do not require a transmission according to the present invention will be apparent to those skilled in the art. Various aspects of the invention have been described above by way of illustration, and the specific embodiments disclosed are not intended to limit the invention to the particular forms disclosed. The particular implementation of the luxury vehicles that utilize man-made fuel and do not require a transmission may vary depending upon the particular context or application. By way of example, and not limitation, the luxury luxury vehicles are controlled by an onboard computer system, and that utilize man-made fuel and do not require a transmission described in the foregoing were principally directed to vehicles that use man-made fuel and do not require transmission implementations; however, similar techniques may instead be applied to aircraft, ships and military tanks that utilize gears, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A vehicle comprising:
an engine portion, said engine portion being operable to power said vehicle, said engine portion comprising an air intake portion, said air intake portion being configured to intake a fluid towards said engine portion;
an exhaust portion, said exhaust portion being configured to carry exhaust from said engine portion to a spew chamber device, said spew chamber device being configured to disperse exhaust; and
a processor portion, said processor portion being disposed to operatively join with a shaft portion, said processor portion being configured to control angular velocity of said shaft portion, said shaft portion being configured to rotate at least one wheel, said shaft portion comprising a shaft conversion device, said shaft conversion device being operable to receive signals from said processor portion, said processor portion further being configured to control distribution of a fuel to said engine portion.

2. The vehicle of claim 1, in which said engine portion comprises a combustion engine.

3. The vehicle of claim 2, in which said engine portion comprises stationary components.

4. The vehicle of claim 3, in which said engine portion comprises a Y-shape.

5. The vehicle of claim 4, wherein said engine portion utilizes a man-made fuel.

6. The vehicle of claim 5, in which said vehicle comprises a fuel tank, said fuel tank being configured to store said man-made fuel, said fuel tank comprising at least one fuel tube, said at least one fuel tube being configured to carry said man-made fuel from said fuel tank to said engine portion.

7. The vehicle of claim 6, in which said engine portion comprises a plurality of ignition prongs, said plurality of ignition prongs being operable to ignite said man-made fuel.

8. The vehicle of claim 7, in which said engine portion comprises a chamber modulator, said chamber modulator being configured to communicate with said fuel tank, said chamber modulator being operable to process the velocity of said fluid entering said vehicle, said chamber modulator further being operable to convert a liquid fuel into a vapor fuel.

9. The vehicle of claim 8, in which said air intake portion comprises an intake filter, said intake filter being configured to filter said fluid.

10. The vehicle of claim 9, in which said air intake portion comprises an air accelerator portion, said air accelerator portion being configured to increase velocity of said fluid.

11. The vehicle of claim 10, wherein said shaft portion positions beneath said processor portion.

12. The vehicle of claim 11, wherein said processor portion is configured to signal to said shaft conversion device to rotate in a forward direction, said processor portion is further configured to signal to said shaft conversion device to rotate in a rearward direction.

13. The vehicle of claim 12, in which said shaft portion comprises an actuating arm, said actuating arm being operatively joined with said processor, said actuating arm being configured to orient at least one wheel in a desired direction.

14. The vehicle of claim 13, in which said actuating arm comprises at least one tie rod, said at least one tie rod being configured to push and pull said at least one wheel in a desired orientation.

15. The vehicle of claim 14, in which said vehicle comprises a steering portion, said steering portion being configured to manipulate said actuating arm to a desired orientation.

16. The vehicle of claim 15, wherein said exhaust portion comprises an exhaust suction device, said exhaust suction device being operable to force exhaust through a combustion valve, said combustion valve being configured to regulate the flow of exhaust.

17. The vehicle of claim 16, wherein said spew chamber is disposed to extend from a rear end of said vehicle.

18. The vehicle of claim 17, wherein said vehicle is operable to communicate with at least one similar vehicle.

19. A method of operating a vehicle comprising:
means for actuating an engine portion;
means for receiving a fluid through an air intake portion;
means for a processor portion to signal to a shaft conversion device to actuate rotation of a shaft portion;
means for orienting said vehicle with a steering portion; and
means for dispersing exhaust through an exhaust portion.

20. A vehicle consisting of:
an engine portion, said engine portion being operable to power said vehicle, said engine portion comprising an air intake portion, said air intake portion being configured to intake a fluid towards said engine portion, said engine portion further comprising a Y-shape, said engine portion further being operable to combust a man-made fuel, said engine portion further comprising a chamber modulator, said chamber modulator being configured to process velocity of said fluid entering said engine portion, said chamber modulator being operable to convert a liquid man-made fuel to a vapor man-made fuel, said engine portion further comprising a plurality of ignition prongs, said plurality of ignition prongs being configured to ignite said man-made fuel;
an exhaust portion, said exhaust portion being configured to carry exhaust from said engine portion to a spew chamber device, said spew chamber device being configured to disperse exhaust, said exhaust portion comprising an exhaust suction device, said exhaust suction device being configured to force exhaust through a combustion valve, said combustion valve being configured to regulate the flow of exhaust;
a processor portion, said processor portion being disposed to operatively join with a shaft portion, said processor portion being configured to control angular velocity of said shaft portion, said shaft portion being configured to rotate at least one wheel, said shaft portion comprising a shaft conversion device, said shaft conversion device being operable to receive signals from said processor portion, said shaft portion further comprising an actuating arm, said actuating arm being configured to orient at least one wheel in a desired direction, said actuating arm comprising at least one tie rod, said at least one tie rod being configured to push and pull said at least one wheel in a desired direction, said processor portion further being configured to control distribution of said man-made fuel to said engine portion; and
a steering portion, said steering portion being configured to control the orientation of said at least one wheel.
